(19) United States
(12) Patent Application Publication
(10) Pub. No.: US 2021/0265706 A1
(43) Pub. Date: Aug. 26, 2021

(54) BATTERY PACK, METHOD FOR MANUFACTURING BATTERY PACK, ELECTRONIC DEVICE, POWER TOOL AND ELECTRIC VEHICLE

(71) Applicant: MURATA MANUFACTURING CO., LTD., Kyoto (JP)

(72) Inventor: Hiroyuki YAMADA, Kyoto (JP)

(21) Appl. No.: 17/314,435

(22) Filed: May 7, 2021

Related U.S. Application Data
(63) Continuation of application No. PCT/JP2019/039086, filed on Oct. 3, 2019.

(30) Foreign Application Priority Data
Nov. 8, 2018 (JP) 2018-210185

(51) Int. Cl. H01M 50/517; H01M 50/507

(52) U.S. Cl. CPC H01M 50/517; B60L 50/64; H01M 50/507

(57) ABSTRACT

A battery pack includes a first moving member configured to move in a first accommodating portion following fastening of a first fastening member from an outside of a housing portion, and a first bus bar and a positive electrode output terminal are brought into contact with each other after the first moving member moves, and a second moving member configured to move in a second accommodating portion following fastening of a second fastening member from the outside of the housing portion, and a second bus bar and a negative electrode output terminal are brought into contact with each other after the second moving member moves.

### CROSS REFERENCE TO RELATED APPLICATIONS

The present application is a continuation of PCT patent application no. PCT/JP2019/039086, filed on Oct. 3, 2019, which claims priority to Japanese patent application no. JP2018-210185 filed on Nov. 8, 2018, the entire contents of which are being incorporated herein by reference.

### BACKGROUND

The present technology generally relates to a battery pack, a method for manufacturing the battery pack, an electronic device, a power tool, and an electric vehicle.

In recent years, use of secondary batteries has expanded. For example, use of a lithium ion secondary battery, which is a typical example of the secondary batteries, has been expanding not only to various electronic devices but also to automobiles, motorcycles, electric flight vehicles, and the like. As the use of the lithium-ion battery has been expanding, the lithium-ion battery is used in various environments. Accordingly, it is also going to be required that durability and mechanical strength of a battery pack including the lithium-ion battery be higher.

### SUMMARY

The present technology generally relates to a battery pack, a method for manufacturing the battery pack, an electronic device, a power tool, and an electric vehicle.

In the conventional battery technology, in order to maintain the firm coupling state, the plurality of fastening portions are provided on a bare cell, and the substrate molding body is screwed at a plurality of spots from the side surfaces thereof. However, the fastening portions needs to be provided on the bare cell by welding, and there has been a problem that a work process increases.

Hence, it is an object of the present technology to provide a battery pack capable of connecting a positive electrode output terminal and a negative electrode output terminal and a battery unit to each other by simple work, the battery unit being accommodated in a case.

According to an embodiment of the present technology, a battery pack is provided. The battery pack includes:

a battery unit;

a housing portion;

a first bus bar on a positive electrode side of the battery unit, the first bus bar being disposed inside the housing portion;

a second bus bar on a negative electrode side of the battery unit, the second bus bar being disposed inside the housing portion;

a positive electrode output terminal connected to the first bus bar;

a negative electrode output terminal connected to the second bus bar;

a first moving member of which movement in a rotation direction is configured to be regulated by a first accommodating portion provided inside the housing portion;

a second moving member of which movement in the rotation direction is configured to be regulated by a second accommodating portion provided inside the housing portion;

a first fastening member to be fastened to the first moving member; and

a second fastening member to be fastened to the second moving member, wherein

each of the housing portion, the positive electrode output terminal, the first bus bar and the first moving member has an opening configured to receive insertion of the first fastening member,

each of the housing portion, the negative electrode output terminal, the second bus bar and the second moving member has an opening configured to receive insertion of the second fastening member,

the first moving member is movable in a direction to the first bus bar in the first accommodating portion after fastening of the first fastening member, and the first bus bar and the positive electrode output terminal are brought into contact with each other by the movement, and

the second moving member is movable in a direction to the second bus bar in the second accommodating portion after fastening of the second fastening member, and the second bus bar and the negative electrode output terminal are brought into contact with each other by the movement.

According to an embodiment of the present technology, a battery pack is provided. The battery pack includes:

a battery unit;

a housing portion;

a first bus bar on a positive electrode side of the battery unit, the first bus bar being disposed inside the housing portion;

a second bus bar on a negative electrode side of the battery unit, the second bus bar being disposed inside the housing portion;

a positive electrode output terminal connected to the first bus bar:

a negative electrode output terminal connected to the second bus bar;

a first moving member of which movement in a rotation direction is configured to be regulated by a first accommodating portion provided inside the housing portion; and

a second moving member of which movement in the rotation direction is configured to be regulated by a second accommodating portion provided inside the housing portion, wherein

each of the housing portion, the positive electrode output terminal, the first bus bar and the first moving member has an opening configured to receive insertion of the first fastening member,

each of the housing portion, the negative electrode output terminal, the second bus bar and the second moving member has an opening configured to receive insertion of the second fastening member,

by fastening of the first fastening member to the first moving member, the first moving member and the first bus bar are in contact with each other, and the first bus bar and the positive electrode output terminal are in contact with each other, and

by fastening of the second fastening member to the second moving member, the second moving member and the second bus bar are in contact with each other, and the second bus bar and the negative electrode output terminal are in contact with each other.

The present technology may be an electronic device, a power tool, and an electric vehicle, each of which includes the battery pack as described herein.

According to an embodiment of the present technology, a method for manufacturing a battery pack is provided. The method for manufacturing the battery pack having:

a battery unit;

a housing portion;

a first bus bar on a positive electrode side of the battery unit, the first bus bar being disposed inside the housing portion;

a second bus bar on a negative electrode side of the battery unit, the second bus bar being disposed inside the housing portion;

a positive electrode output terminal connected to the first bus bar;

a negative electrode output terminal connected to the second bus bar;

a first moving member of which movement in a rotation direction is configured to be regulated by a first accommodating portion provided inside the housing portion; and

a second moving member of which movement in the rotation direction is configured to be regulated by a second accommodating portion provided inside the housing portion, in which

each of the housing portion, the positive electrode output terminal, the first bus bar and the first moving member has an opening configured to receive insertion of the first fastening member, and

each of the housing portion, the negative electrode output terminal, the second bus bar and the second moving member has an opening configured to receive insertion of the second fastening member,

the method including the steps of:

moving the first moving member in the first accommodating portion by fastening the first fastening member to the first moving member from an outside of the housing portion, and by moving the first moving member, bringing the first moving member and the first bus bar into contact with each other, and bringing the first bus bar and the positive electrode output terminal into contact with each other; and

moving the second moving member in the second accommodating portion by fastening the second fastening member to the second moving member from the outside of the housing portion, and by moving the second moving member, bringing the second moving member and the second bus bar into contact with each other, and bringing the second bus bar and the negative electrode output terminal into contact with each other.

According to the present technology, the positive electrode output terminal and the negative electrode output terminal, which are led out from the case, and the battery unit and the bus bars, which are accommodated in the case, can be connected to each other only by fastening the screws from the outside of the case. In this way, the positive electrode output terminal and the negative electrode output terminal can be connected to the battery unit and the bus bars, which are housed in the case, by a simple operation. Moreover, according to the other configuration of the present technology, a structure can be achieved, in which a difference in linear expansion coefficient is prevented from occurring as much as possible. Thus, it is made possible to maintain strength of the structure after fastening the screws and the like for a long period of time, and reliability of the battery pack that can be used in harsh environments (for example, at an extremely low temperature of approximately −45° C. or at a high temperature of approximately 125° C.) can be improved.

It should be noted that the effects exemplified in the present description are examples, and the contents of the present technology are not limitedly interpreted by the effects.

### BRIEF DESCRIPTION OF THE FIGURES

FIG. 1 is a perspective view illustrating an external appearance example of a battery pack according to an embodiment of the present technology.

FIG. 2 is a perspective view illustrating a state in which an upper case and lower case of the battery pack according to an embodiment of the present technology are separated from each other.

FIG. 3 is an exploded perspective view referred to at a time of explaining a configuration of the battery pack according to an embodiment of the present technology.

FIG. 4 is an exploded perspective view referred to at a time of explaining a configuration of a bus bar unit according to an embodiment of the present technology.

FIG. 5 is a top view referred to at a time of explaining a connection mode between bus bars and respective battery cells according to an embodiment of the present technology.

FIG. 6 is a view referred to at a time of explaining a connection mode using a relay bus bar according to an embodiment of the present technology.

FIGS. 7A and 7B are views referred to at a time of explaining a method for manufacturing the battery pack according to an embodiment of the present technology.

FIGS. 8A and 8B are views referred to at the time of explaining the method for manufacturing the battery pack according to an embodiment of the present technology.

FIGS. 9A and 9B are views referred to at the time of explaining the method for manufacturing the battery pack according to an embodiment of the present technology.

FIG. 10 is a view for explaining a modified example according to an embodiment of the present technology.

FIG. 11 is a diagram illustrating a circuit configuration of a wearable device according to an embodiment of the present technology.

FIG. 12 is a diagram illustrating a configuration example of an electric vehicle according to an embodiment of the present technology.

### DETAILED DESCRIPTION

The embodiment and the like, which will be described below, are suitable specific examples of the present technology, and the contents of the present technology are not limited to the embodiment and the like. Moreover, it is possible to appropriately combine the embodiment, the modified example, and the application examples, which will be described below, with one another. Furthermore, in each of the embodiment and the modified example, the same reference numerals are assigned to the same or homogeneous configurations, and a duplicate description will be omitted as appropriate. Moreover, members shown in the claims are not specified as members of the embodiment. In particular, dimensions, materials and shapes of constituent members described in the embodiment, relative arrangements thereof, directions thereof such as up, down, left, and right, and the like are not described to limit the scope of the present technology only thereto unless particularly described to limit the same thereto, and are described as merely description examples. It should be understood that, the sizes and positional relationships and the like of the members illustrated in the respective drawing may be exaggerated for the sake of clarity of the explanation.

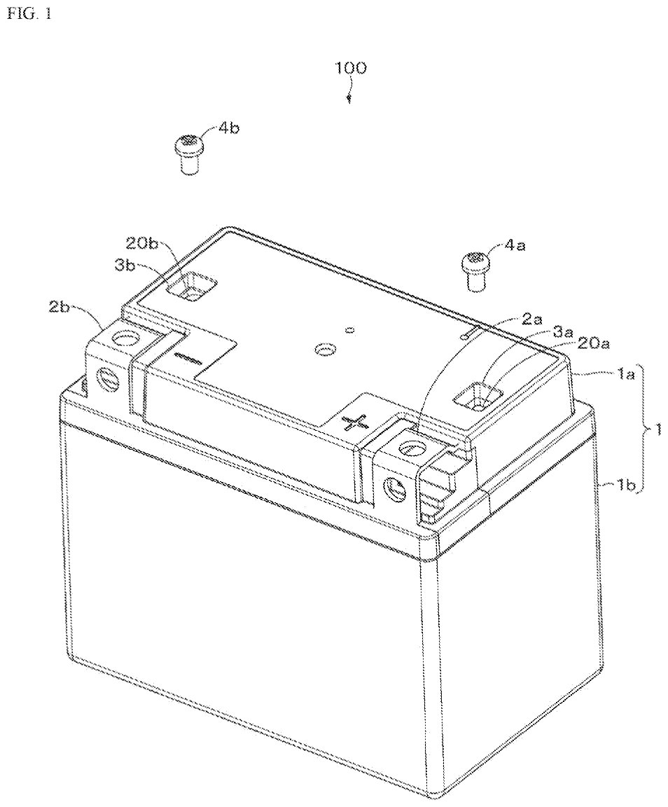

FIG. 1 is a perspective view illustrating an external appearance example of a battery pack (battery pack 100) according to an embodiment of the present technology. The battery pack 100 has a box-shaped case 1. In the present embodiment, the case 1 includes an upper case 1a and a lower case 1b which are vertically divisible. In the present embodiment, the upper case 1a corresponds to a housing portion.

The battery pack 100 includes a positive electrode output terminal 2a and a negative electrode output terminal 2b. The positive electrode output terminal 2a and the negative electrode output terminal 2b are composed of a conductive metal such as copper and aluminum. The positive electrode output terminal 2a and the negative electrode output terminal 2b have, for example, a shape having a plurality of bent portions, and are supported by the upper case 1a in such a way that a part of each thereof is exposed to the outside of the case 1, and other spot is disposed in the inside of the upper case 1a. Then, the positive electrode output terminal 2a extends to the inside of the upper case 1a and is connected to a predetermined relay bus bar, whereby the positive electrode output terminal 2a is electrically connected to a positive electrode of a battery unit to be described later. Moreover, the negative electrode output terminal 2b extends to the inside of the upper case 1a and is connected to a predetermined bus bar, whereby the negative electrode output terminal 2b is electrically connected to a negative electrode of the battery unit to be described later.

A first upper case opening 3a and a second upper case opening 3b are provided at predetermined positions on an upper surface of the upper case 1a. The first upper case opening 3a and the second upper case opening 3b have, for example, a quadrangular shape. A screw 4a (first fastening member) is inserted into the first upper case opening 3a. A screw 4b (second fastening member) is inserted into the second upper case opening 3b. The screws 4a and 4b are composed of a metal such as iron, stainless steel, and aluminum.

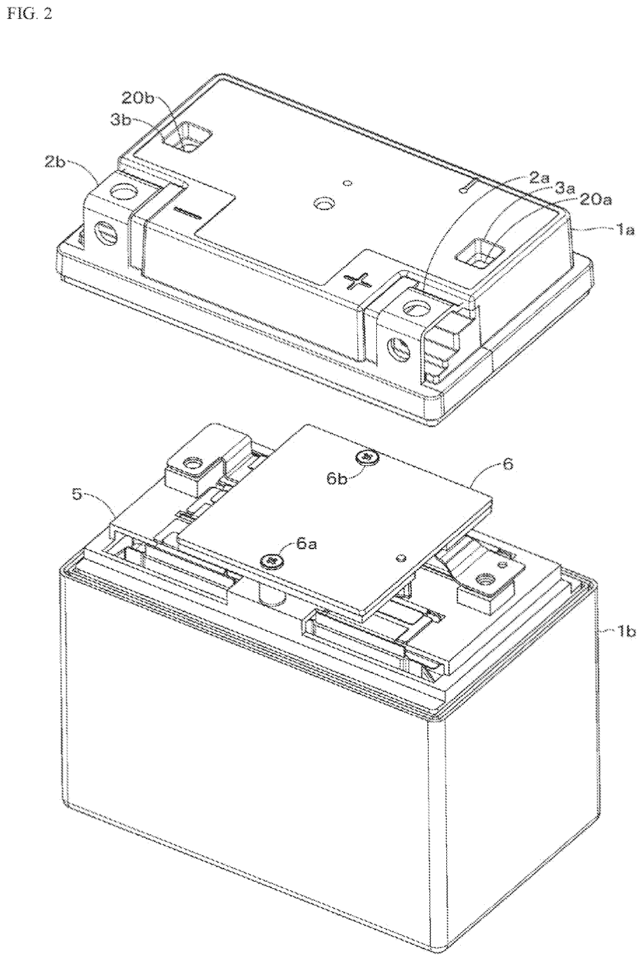

FIG. 2 is a perspective view illustrating a state in which the upper case 1a and the lower case 1b are separated from each other. A plate-shaped bus bar unit 5 is attached above the lower case 1b (inside the upper case 1a). Details of the bus bar unit 5 will be described later. A printed circuit board 6 is connected to the bus bar unit 5. The printed circuit board 6 includes a circuit for performing a control, a protecting operation and the like of the battery pack 100. The printed circuit board 6 is fastened to the bus bar unit 5 by, for example, screwing screws 6a and 6b thereto.

As illustrated in FIGS. 1 and 2, the positive electrode output terminal 2a is provided with an opening 20a (hereinafter, may be referred to as a “positive electrode terminal opening”), and the negative electrode output terminal 2b is provided with an opening 20b (hereinafter, may be referred to as a “positive electrode terminal opening”). Hereinafter, it may be referred to as a “negative electrode terminal opening”). The positive electrode terminal opening 20a is provided at a position disposed below the first upper case opening 3a so that the screw 4a is insertable thereinto. The negative electrode terminal opening 20b is provided at a position disposed below the second upper case opening 3b so that the screw 4b is insertable thereinto. The positive electrode output terminal 2a and the negative electrode output terminal 2b have, for example, a shape having a plurality of bent portions formed by bending a plate-shaped metal piece a plurality of times. It is desirable that each of both terminals be integrally formed; however, each may be formed by bonding the same or similar metal members to one another.

Moreover, portions of both terminals, which extend to the inside of the upper case 1a, may be fixed to the inside of the upper case 1a by a mold resin or the like in a mode of avoiding the positive electrode terminal opening 20a and the negative electrode terminal opening 20b (not shown). Furthermore, ends of both terminals, which are opposite to such extending portions, may be fixed, for example, at a side portion of the upper case 1a in a mode of being embedded in the upper case 1a (not shown).

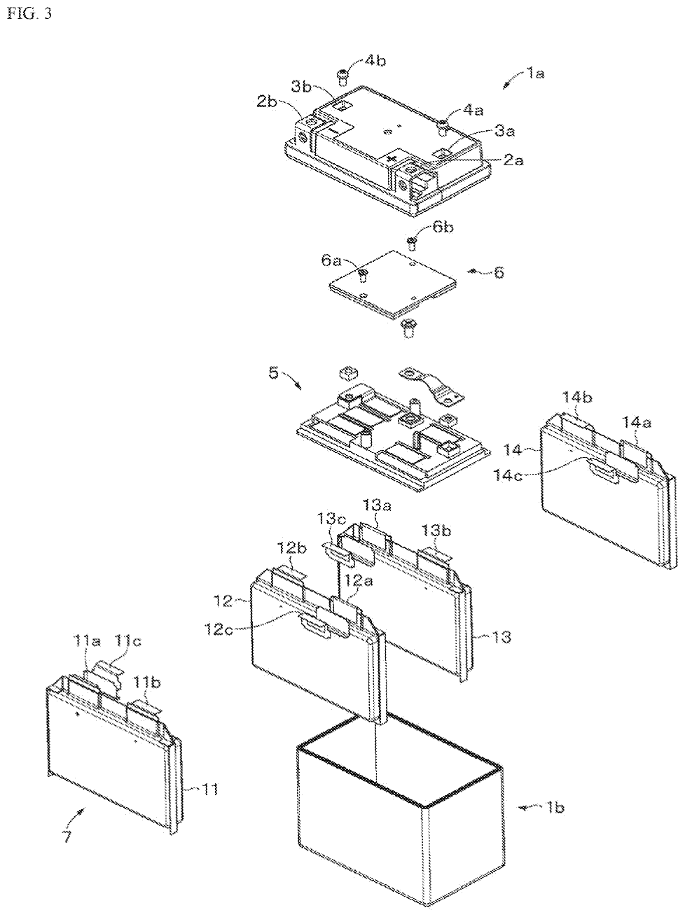

A description will be given of details of the configuration of the battery pack 100 according to the embodiment with reference to FIGS. 3 to 6. FIG. 3 is an exploded perspective view of the battery pack 100. The battery pack 100 includes a battery unit 7, which is accommodated in the lower case 1b, in addition to the above-mentioned case 1 (upper case 1a and lower case 1b), bus bar unit 5, printed circuit board 6, and the like.

The battery unit 7 includes, for example, a plurality of lithium ion battery cells (hereinafter, simply referred to as battery cells). In the present embodiment, the battery unit 7 includes four battery cells (battery cells 11, 12, 13, 14) connected in series to one another. Each of the battery cell has a positive electrode tab and a negative electrode tab. Specifically, the battery cell 11 includes a positive electrode tab 11a and a negative electrode tab 11b. The battery cell 12 includes a positive electrode tab 12a and a negative electrode tab 12b. The battery cell 13 includes a positive electrode tab 13a and a negative electrode tab 13b. The battery cell 14 includes a positive electrode tab 14a and a negative electrode tab 14b. It should be understood that, in the present embodiment, as illustrated in FIG. 3, the respective battery cells are configured to further have tabs called joint tabs (joint tabs 11c, 12c, 13c, 14c); however, the joint tabs may be omitted.

Next, a description will be given of details of the bus bar unit 5 with reference to an exploded perspective view illustrated in FIG. 4. The bus bar unit 5 has a plate shape, and includes a base 21 composed of resin or the like. The base 21 is provided with a first nut accommodating portion (first accommodating portion) 22a and a second nut accommodating portion (second accommodating portion) 22b which protrude upward. The first nut accommodating portion 22a is provided in the vicinity of one end of the base 21, and the second nut accommodating portion 22b is provided in the vicinity of other end of the base 21. Both accommodating portions have, for example, a quadrangular shape.

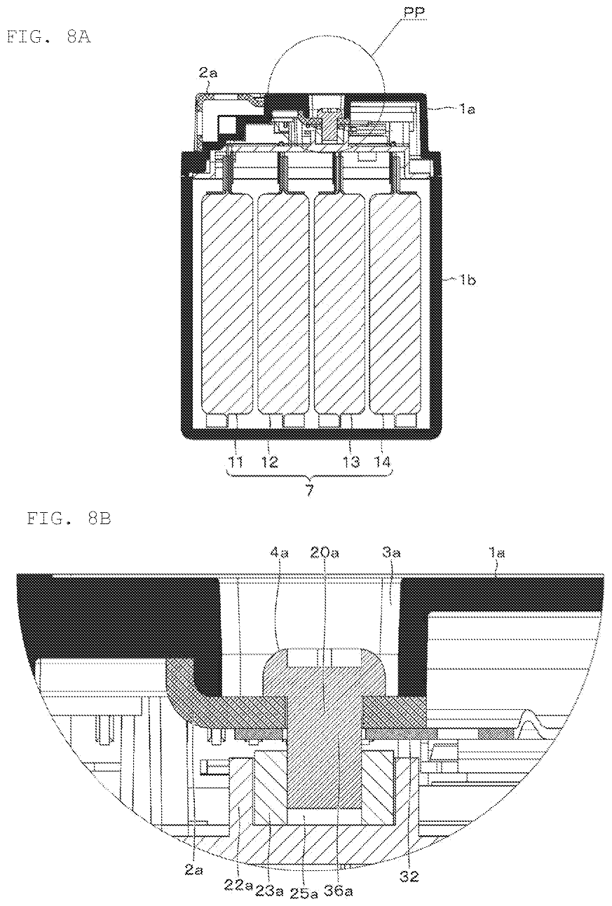

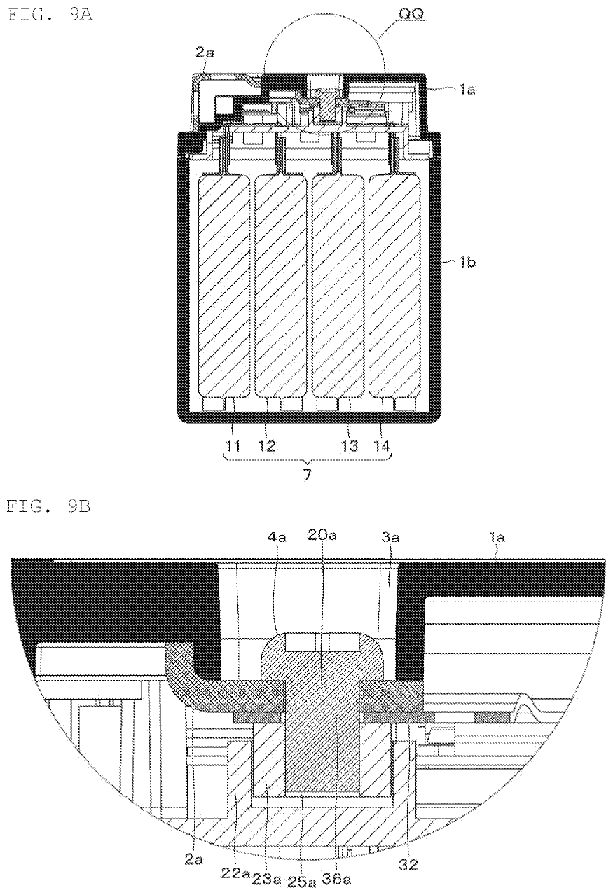

A quadrangular first nut 23a (first moving member) is accommodated in the first nut accommodating portion 22a. A size of an internal space of the first nut accommodating portion 22a is set to substantially the same size as a size of the first nut 23a. Therefore, in a state in which the first nut 23a is accommodated in the first nut accommodating portion 22a, movement of the first nut 23a in a rotation direction (horizontal rotation in FIGS. 4 and 8B) is regulated by the first nut accommodating portion 22a. It should be understood that a rotation direction in an actual battery fabrication process is not limited to the horizontal direction, and may be a vertical direction or an oblique direction depending on a direction in which the screw 4a is inserted (the same applies to the screw 4b). The definition of “rotation direction” described here is the same in the present description.

A quadrangular second nut 23b (second moving member) is accommodated in the second nut accommodating portion 22b. A size of an internal space of the second nut accommodating portion 22b is set to substantially the same size as a size of the second nut 23b. Therefore, in a state in which the second nut 23b is accommodated in the second nut accommodating portion 22b, movement of the second nut 23b in the rotation direction is regulated by the second nut accommodating portion 22b. It should be understood that, here, the second nut 23b (and the internal space of the second nut accommodating portion 22b corresponding thereto) has the same shape and the same size as the first nut 23a (and the internal space of the first nut accommodating portion 22a corresponding thereto); however, the first nut 23a and the second nut 23b may have different shapes and different sizes.

The first nut 23a and the second nut 23b are composed of a metal such as iron and stainless steel. The first nut 23a has a circular first nut opening 25a in a center thereof. The first nut accommodating portion 22a is provided on the base 21 so that the screw 4a can be inserted into the first nut opening 25a. Specifically, the first nut accommodating portion 22a is provided at a position below the first upper case opening 3a and the positive electrode terminal opening 20a. The second nut 23b has a circular second nut opening 25b in a center thereof. The second nut accommodating portion 22b is provided on the base 21 so that the screw 4b can be inserted into the second nut opening 25b. Specifically, the second nut accommodating portion 22b is provided at a position below the second upper case opening 3b and the negative electrode terminal opening 20b.

The bus bar unit 5 includes bus bars and a relay bus bar. The bus bar unit 5 according to the present embodiment includes five bus bars (bus bars 31a, 31b, 31c, 31d, 31e) and one relay bus bar 32. The number of bus bars and relay bus bar can be changed as appropriate.

The bus bar 31a has a thin plate shape. Likewise, the bus bars 31b to 31d also have a thin plate shape. The bus bar 31e has a step portion in which a vicinity of a center bends upward, and has an L-shaped shape when viewed from above. The bus bar 31e has a circular bus bar opening 35 formed in the vicinity of an end thereof located above. The bus bar opening 35 is provided at a position into which the screw 4b can be inserted. Specifically, the bus bar opening 35 is provided at a position below the second upper case opening 3b and the negative electrode terminal opening 20b, which is also a position above the second nut opening 25b.

The relay bus bar 32 has a thin plate-like shape as a whole, and the vicinity of a center thereof is slightly curved upward from below. A circular relay bus bar opening 36a is provided in the vicinity of an end of the relay bus bar 32, which is located below the same. A circular relay bus bar opening 36b is provided in the vicinity of an opposite end of the relay bus bar 32.

The relay bus bar opening 36a is provided at a position into which the screw 4a can be inserted. Specifically, the relay bus bar opening 36a is provided at a position below the first upper case opening 3a and the positive electrode terminal opening 20a, which is also a position above the first nut opening 25a. A screw 41 is inserted into the relay bus bar opening 36b, and the screw 41 is screwed into a screw hole 42 provided in the vicinity of a center of an end of the base 21, whereby one end side of the relay bus bar 32 is fastened to the base 21.

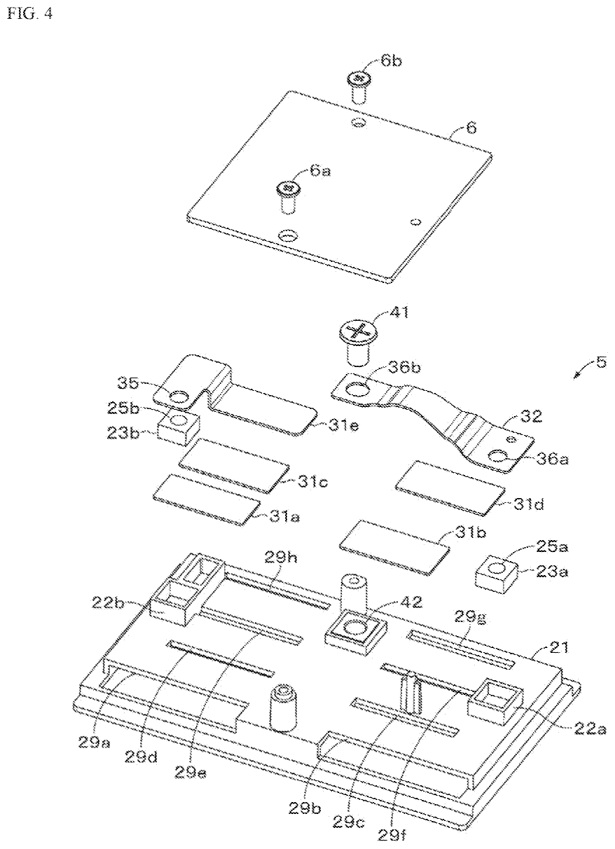

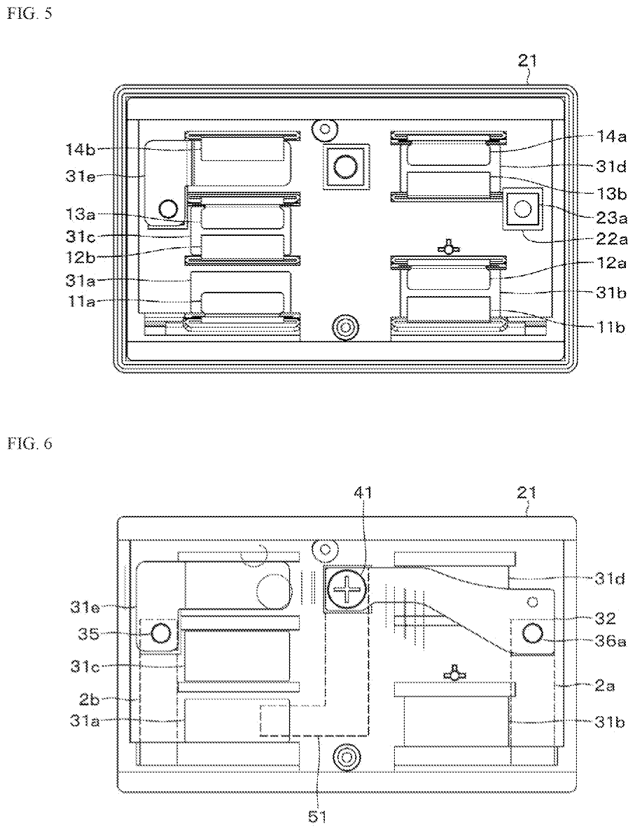

The five bus bars mentioned above are placed on the base 21. Each of the bus bars may be locked by a protrusion or the like provided on the base 21, or may be adhered by a double-sided tape or the like. For example, as illustrated in FIG. 5, when the base 21 is viewed from above, the bus bars 31a, 31c and 31e are provided so as to be aligned from a lower left side to an upper left side. Moreover, when the base 21 is viewed from above, the bus bars 31b and 31d are provided so as to be aligned from a lower right side to an upper right side.

FIG. 5 is a top view for explaining a connection mode between the bus bars and the battery cells 11 to 14, and the respective battery cells are arranged below the base 21 (back side of a paper surface of FIG. 5). As such a connection mode between each of the bus bars and each of the tabs of the battery cells, for example, the tab of the battery cell is extended upward with a tab extension portion 29 (see FIG. 4) formed of a slit or a gap, which is provided in the base 21, interposed therebetween and the tab of the battery cell is welded to each bus bar by a laser or the like, whereby an electrical connection is made. As illustrated in FIG. 4, in the present embodiment, eight tab extension portions 29 (tab extension portions 29a, 29b, . . . 29h) are provided, but the present technology is not limited to this. Moreover, as illustrated in FIG. 5, in the present embodiment, the positive electrode tab 11a of the battery cell 11 extended from the tab extension portion 29a is connected to the bus bar 31a. The negative electrode tab 11b of the battery cell 11 extended from the tab extension portion 29b and the positive electrode tab 12a of the battery cell 12 extended from the tab extension portion 29c are connected to the bus bar 31b. The negative electrode tab 12b of the battery cell 12 extended from the tab extension portion 29d and the positive electrode tab 13a of the battery cell 13 extended from the tab extension portion 29e are connected to the bus bar 31c. The negative electrode tab 13b of the battery cell 13 extended from the tab extension portion 29f and the positive electrode tab 14a of the battery cell 14 extended from the tab extension portion 29g are connected to the bus bar 31d. The negative electrode tab 14b of the battery cell 14 extended from the tab extension portion 29h is connected to the bus bar 31e.

It should be understood that, by using the relay bus bar 32 as in the present embodiment, the positive electrode output terminal 2a and the negative electrode output terminal 2b can be led out to the outside at an appropriate interval. This point will be described with reference to FIG. 6. For example, as illustrated in FIG. 6, it is assumed that the negative electrode output terminal 2b and the bus bar 31e on the negative electrode side are brought into contact with each other using the screw 4b. On the other hand, the positive electrode output terminal 2a needs to be brought into contact with the bus bar 31a on the positive electrode side. Here, when the positive electrode output terminal 2a is brought into contact with the bus bar 31a, and a part thereof is led out in the same direction as in an exposed spot of the negative electrode output terminal 2b, then there is a risk that it may be made impossible to ensure a distance between the positive electrode output terminal 2a and the negative electrode output terminal 2b by a certain amount or more. When the distance between the positive electrode output terminal 2a and the negative electrode output terminal 2b cannot be ensured by a certain amount or more, it becomes necessary to prevent an occurrence of a short circuit, and so one, and this results in a deterioration of usability of the battery pack 100.

Accordingly, as illustrated in FIG. 6, the bus bar 31a and one end side of the relay bus bar 32 are connected to each other by a connecting portion 51. Then, if the positive electrode output terminal 2a is brought into contact with other end side of the relay bus bar 32, and a part of the positive electrode output terminal 2a is led out to the outside, then even when the positive electrode output terminal 2a and the negative electrode output terminal 2b are lead out in the same direction, the distance between the positive electrode output terminal 2a and the negative electrode output terminal 2b can be ensured. Note that the connecting portion 51 includes at least one of a harness, a conductive metal plate, a fuse, a field effect transistor (FET), and/or a positive temperature coefficient (PTC) thermistor. As a specific example of the connecting portion 51, mentioned is a configuration in which the harness, the conductive metal plate or the like is used, and a spot where the harness or the like is disposed is provided with a safety mechanism such as the fuse that blows due to an overcurrent, and the FET and the PTC thermistor for charge/discharge control. The PTC thermistor has a characteristic that does not allow a current to flow when the temperature exceeds a predetermined temperature, in which the current stops when the temperature exceeds a predetermined temperature. In this way, it is made possible to control the battery cell so as to prevent overheat thereof. As mentioned above, in the present embodiment, since the bus bar 31e is connected to the negative electrode output terminal 2b, the bus bar 31e corresponds to a second bus bar. Moreover, since the bus bar 31a is connected with the relay bus bar 32 interposed therebetween, a configuration including the bus bar 31a and the relay bus bar 32 corresponds to a first bus bar.

Next, a description will be given of a method for manufacturing the battery pack 100 with reference to FIGS. 3, 4 and 7 to 9. A description will be given below mainly of a manufacturing method related to the present technology, specifically, a method of bringing the positive electrode output terminal 2a and the relay bus bar 32 in contact with each other, and a method of bringing the negative electrode output terminal 2b and the bus bar 31e in contact with each other. Known manufacturing methods can be applied to other manufacturing methods of the battery pack 100.

First, a brief description will be given of a method for manufacturing a configuration of the bus bar unit illustrated in FIG. 4. The positive electrode tabs and the negative electrode tabs of the respective battery cells are individually connected to the bus bars of the bus bar unit 5 by laser welding or the like. Then, the printed circuit board 6 is attached to the bus bar unit 5 by screwing the screws 6a and 6b thereto. Then, after the battery unit 7 that has received the contact of the bus bar unit 5 is accommodated in the lower case 1b, the upper case 1a is attached thereto (see FIGS. 3 and 8). Note that an order of the steps mentioned above can be appropriately changed.

In a state in which the respective constituents are positioned, a cavity that communicates in the vertical direction is composed of the first upper case opening 3a, the positive electrode terminal opening 20a, the relay bus bar opening 36a and the first nut opening 25a so that the screw 4a can be inserted thereinto and fastened.

In a state in which the respective constituents are positioned, a cavity that communicates in the vertical direction is composed of the second upper case opening 3b, the negative electrode terminal opening 20b, the bus bar opening 35 and the second nut opening 25b so that the screw 4b can be inserted thereinto and fastened.

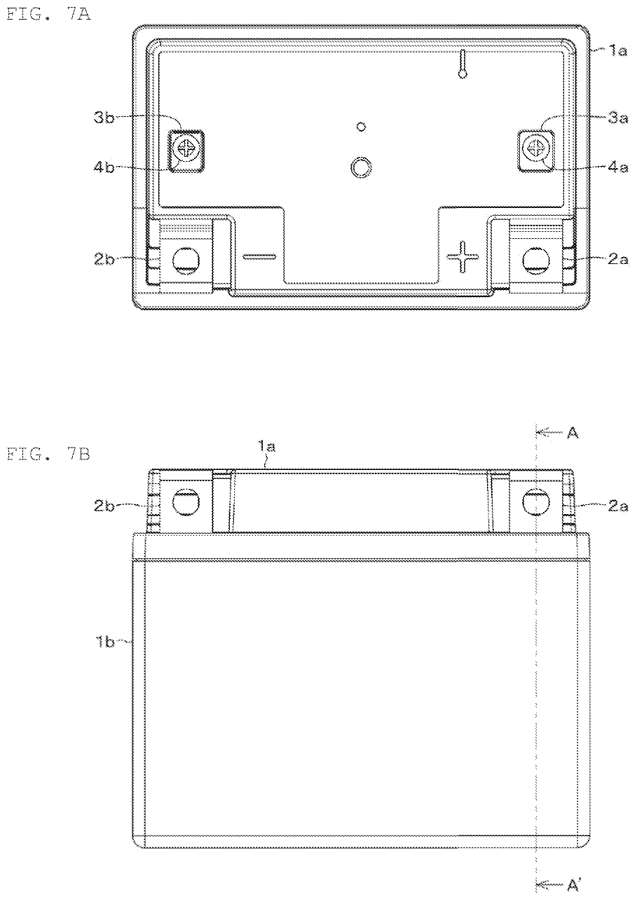

FIGS. 7A and 7B are a top view and front view of the battery pack 100, which are common to before and after fastening the screw 4a, respectively. FIG. 8A is a cross-sectional view of the battery pack 100 when the battery pack 100 is cut along a cutting line A-A′ in FIG. 7B before the screw 4a is fastened. FIG. 8B is an enlarged view of a portion surrounded by reference symbol PP in FIG. 8A.

As illustrated in FIGS. 7A and 8B, the screw 4a is inserted into the cavity that communicates in the vertical direction and includes the first upper case opening 3a, the positive electrode terminal opening 20a, and the like.

As illustrated in FIG. 8B, the first nut 23a is accommodated in the first nut accommodating portion 22a. Specifically, the first nut 23a is placed on a bottom of the first nut accommodating portion 22a. Note that the first nut 23a is only required to be accommodated in the first nut accommodating portion 22a to an extent that the movement of the first nut 23a in the rotation direction is regulated, and all the first nut 23a does not have to be accommodated in the first nut accommodating portion 22a, and a part of the first nut 23a may be located outside the first nut accommodating portion 22a. The same applies to the second nut 23b accommodated in the second nut accommodating portion 22b.

In a state in which the first nut 23a is accommodated in the first nut accommodating portion 22a, the relay bus bar 32 and the positive electrode output terminal 2a are disposed so as to be laminated (layered) on each other in order from the lower side between the screw 4a (specifically, a flange of the screw 4a) and the first nut 23a. Note that, in FIG. 8B, the relay bus bar 32 and the positive electrode output terminal 2a appear to be in contact with each other, but in reality, there is a gap or only a partial contact is made therebetween, and the contact between both is imperfect. Hence, as will be described later, it is necessary to sandwich the relay bus bar 32 and the positive electrode output terminal 2a by the screw 4a and the first nut 23a.

Specifically, a fastening operation of applying predetermined tightening torque to the screw 4a is performed. Such a fastening operation may be performed automatically, or may be performed manually.

FIG. 9A is a cross-sectional view of the battery pack 100 when the battery pack 100 is cut along the cutting line A-A′ in FIG. 7B after the screw 4a is fastened. FIG. 9B is an enlarged view of a portion surrounded by reference symbol QQ in FIG. 9A.

Since vertical movement of the first nut 23a is not regulated, the first nut 23a is pulled upward by axial force (tensile force) that acts following the fastening of the screw 4a, and the first nut 23a moves upward. Then, the upward movement of the first nut 23a is regulated at such a spot where the relay bus bar 32 and the positive electrode output terminal 2a are sandwiched by the screw 4a and the first nut 23a. That is, after the first nut 23a is moved, then as illustrated in FIG. 9B, the relay bus bar 32 and the positive electrode output terminal 2a are sandwiched by the screw 4a and the first nut 23a, and reliable electrical contact between the relay bus bar 32 and the positive electrode output terminal 2a is achieved.

It should be understood that, though not shown, contact between the negative electrode output terminal 2b and the bus bar 31e is also achieved in a similar manner. Hereinafter, a schematic description will be given. The screw 4b is inserted into the cavity that communicates in the vertical direction and includes the second upper case opening 3b and the negative electrode terminal opening 20b. Moreover, the second nut 23b is accommodated in the second nut accommodating portion 22b. In a state in which the second nut 23b is accommodated in the second nut accommodating portion 22b, the bus bar 31e and the negative electrode output terminal 2b are disposed so as to be laminated (layered) on each other in order from the lower side between the screw 4b (specifically, a flange of the screw 4b) and the second nut 23b.

Then, a fastening operation of applying predetermined tightening torque to the screw 4b is performed. Since vertical movement of the second nut 23b is not regulated, the second nut 23b is pulled upward by axial force (tensile force) that acts following the fastening of the screw 4b, and the second nut 23b moves upward. Then, the upward movement of the second nut 23b is regulated at such a spot where the bus bar 31e and the negative electrode output terminal 2b are sandwiched by the screw 4b and the second nut 23b. That is, after the second nut 23b is moved, the bus bar 31e and the negative electrode output terminal 2b are sandwiched by the screw 4b and the second nut 23b, and contact between the bus bar 31e and the negative electrode output terminal 2b is achieved. It should be understood that, desirably, the fastening operations of the screw 4a and the screw 4b are performed simultaneously. Moreover, though the example in which the first nut 23a and the second nut 23b are pulled upward has been described in the present embodiment, the first nut 23a and the second nut 23b may move in the horizontal direction or an oblique direction depending on an insertion direction of the screws 4a and 4b.

The embodiment of the present technology has been described above. According to the embodiment of the present technology, the following effects are obtained.

In the present embodiment, the positive electrode output terminal and the negative electrode output terminal, which are led out from the case, and the battery unit accommodated in the case can be connected to each other only by fastening the screws from the outside of the case. In this way, the positive electrode output terminal and the negative electrode output terminal and the battery unit accommodated in the case can be connected to each other by an easy operation. Moreover, unlike the case of wiring an interposed cable or the like, since fastening positions are set in advance, there is no risk that the screws may interfere with other parts. Furthermore, since the case is only required to be provided with two openings for fastening the screws, airtightness and waterproofness will not be extremely deteriorated.

Moreover, in another configuration of the present embodiment, a configuration has been adopted, in which the bus bar unit and the positive electrode output terminal, which receive contact, and the screws and the nuts for the contact are all composed of the same material (in the embodiment, metal (the same metal material may be used)), whereby linear expansion coefficients thereof are set to be almost the same, and a difference between the linear expansion coefficients is prevented from occurring as much as possible. With such a configuration, an occurrence of loosening of the screws, which is caused by the difference between the linear expansion coefficients, can be prevented. Hence, the loosening of the screws is less likely to be caused by a change of an environmental temperature, a contact structure with stable strength can be achieved, and reliability of the battery pack can be improved.

Although the embodiment of the present technology has been specifically described above, the contents of the present technology are not limited to the above-mentioned embodiment, and various modifications based on the technical idea of the present technology are possible. A modified example will be described below.

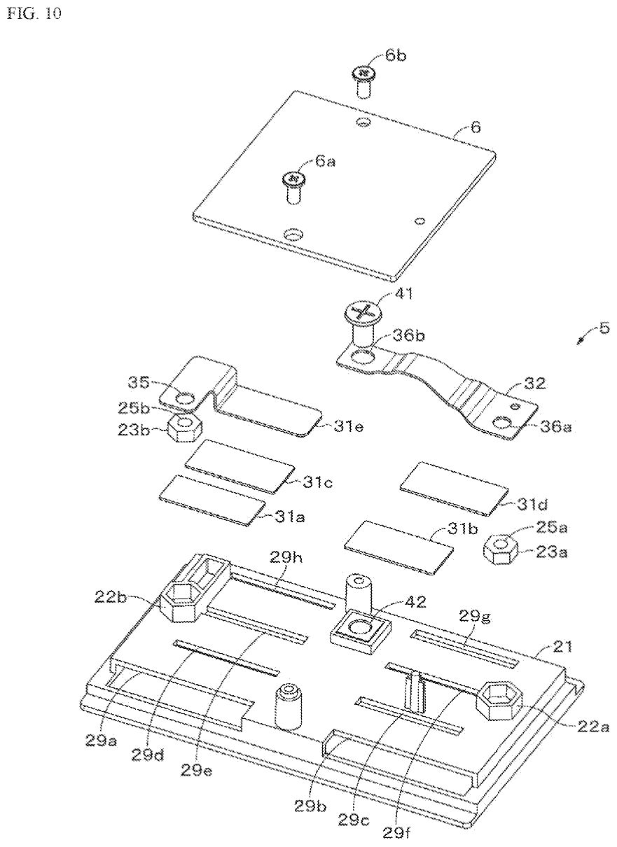

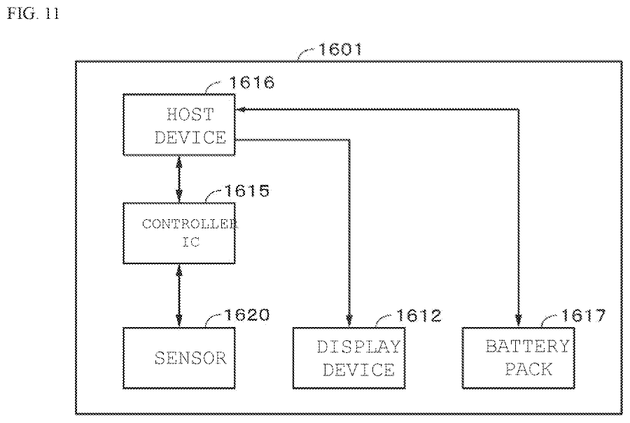

For example, the shape of the first nut 23a and the second nut 23b is not limited to the quadrangular shape, and may be other shapes, for example, a hexagonal shape as illustrated in FIG. 10. However, in the case of hexagonal nuts, holding force against the tightening torque is weaker than that of the quadrangular nuts, so that there is a risk that the nut may rotate when the screws are tightened. Hence, the shape of the nuts is preferably quadrangular.

In the above-mentioned embodiment, the description has been given of the configuration in which the output on the positive electrode side of the battery unit is routed to a predetermined spot using the relay bus bar; however, such a configuration may be adopted, in which the output on the negative electrode side of the battery unit is routed to a predetermined spot using the relay bus bar. Specifically, a configuration may be adopted, in which the bus bar 31e is connected to one end side of the relay bus bar, and the other end side of the relay bus bar is connected to the negative electrode output terminal 2b.

In the above-mentioned embodiment, the connection mode using the relay bus bar has been described; however, the relay bus bar may not be provided.

In the case of using the connecting portion illustrated in FIG. 6, a contact structure similar to that in the embodiment may be applied to the spot to which the screw 41 is fastened.

Other configurations may be added to the battery pack according to the above-mentioned embodiment as appropriate. A battery other than a lithium-ion battery, such as a lead battery, can be applied to the battery unit.

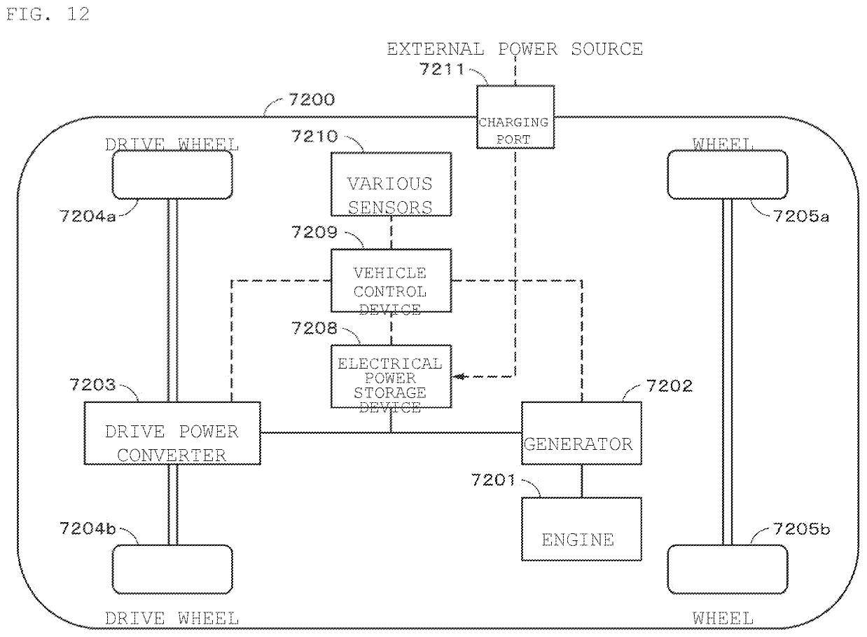

A description will be given below of an application example in which the present technology is applied to an electronic device. FIG. 11 illustrates an example of a circuit configuration of an electronic device 1601. In addition to the display device 1612 mentioned above, the electronic device 1601 includes a controller IC 1615 as a drive control unit, a sensor 1620, a host device 1616, and a battery pack 1617 as a power source. The sensor 1620 may include the controller IC 1615.

The sensor 1620 is capable of detecting both pressing and bending. The sensor 1620 detects a change in capacitance, which corresponds to the pressing, and outputs, to the controller IC 1615, an output signal corresponding thereto. Moreover, the sensor 1620 detects a change in resistance value (resistance change), which corresponds to the bending, and outputs, to the controller IC 1615, an output signal corresponding thereto. The controller IC 1615 detects the pressing and bending of the sensor 1620 on the basis of the output signals from the sensor 1620, and outputs, to the host device 1616, information corresponding to results of detecting the same.

The host device 1616 executes various processes on the basis of the information supplied from the controller IC 1615. For example, the host device 1616 executes processes such as displaying character information and image information on the display device 1612, moving a cursor displayed on the display device 1612, and scrolling a screen.

The display device 1612 is, for example, a flexible display device, which displays a screen on the basis of a video signal, a control signal and the like which are supplied from the host device 1616.

Examples of the display device 1612 include, but are not limited to, a liquid crystal display, an electro luminescence (EL) display, and electronic paper.

The battery pack 1617 includes the battery pack according to the above-mentioned embodiment or the modified example thereof.

The battery pack according to the present technology can be applied to various electronic devices, and is mainly suitable for power tools, electrically assisted bicycles, batteries for robots, power storage modules, power storage systems, and the like. Examples of the power tools include electric drills, chainsaws, and garden tools. The batteries for robots include flying object robots such as drones. The power storage systems include road conditioners (devices which can store cheap electricity at night and supply (discharge) electricity during peak daytime demand), and hybrid systems which use natural energy, such as solar cells.

Examples of electronic devices other than those in the above-mentioned application example include audio devices, gaming devices, navigation systems, home appliances such as air conditioners, lighting devices, medical devices, toys, and the like.

Moreover, if the battery pack can be miniaturized, then the battery pack can also be applied to notebook personal computers, tablet computers, mobile phones (including smartphones), personal digital assistants (PDAs), display devices (LCDs, EL displays, electronic papers, and the like), imaging devices (for example, digital still cameras, digital video cameras, and the like), smart watches, and glasses-type terminals (head mounted displays (HMD), and the like). As a matter of course, the application scope of the present technology is not limited to the above.

Referring to FIG. 12, a description will be given of an example in which the present technology is applied to a power storage system for a vehicle. FIG. 12 schematically illustrates a configuration of a hybrid vehicle that adopts a series hybrid system to which the present technology is applied. The series hybrid system is a vehicle that travels by an electrical power drive power converter using electrical power generated by a generator powered by an engine or the electrical power temporarily stored in a battery.

On this hybrid vehicle 7200, there are mounted an engine 7201, a generator 7202, an electrical power drive power converter 7203, a drive wheel 7204a, a drive wheel 7204b, a wheel 7205a, a wheel 7205b, an electrical power storage device 7208, a vehicle control device 7209, various sensors 7210, and a charging port. 7211. The electrical power storage device 7208 includes the battery pack according to either the above-mentioned embodiment or the modified example thereof.

The hybrid vehicle 7200 travels using the electrical power drive power converter 7203 as a power source. An example of the electrical power drive power converter 7203 is a motor.

The electrical power drive power converter 7203 operates by the electrical power of the electrical power storage device 7208, and rotational force of the electrical power drive power converter 7203 is transmitted to the drive wheels 7204a and 7204b. It should be understood that, by using DC-AC or reverse (AC-DC) conversion, the electrical power drive power converter 7203 is applicable whichever it may be an AC motor or a DC motor. The various sensors 7210 control an engine speed via the vehicle control device 7209, and control an opening degree (throttle opening degree) of a throttle valve (not shown). The various sensors 7210 include a speed sensor, an acceleration sensor, an engine speed sensor, and the like.

Rotational force of the engine 7201 is transmitted to the generator 7202, and electrical power generated by the generator 7202 using the rotational force can be stored in the electrical power storage device 7208.

When the hybrid vehicle decelerates by a braking mechanism (not shown), resistance force during the deceleration is applied as rotational force to the electrical power drive power converter 7203, and regenerative electrical power generated by the electrical power drive power converter 7203 using this rotational force is stored in the electrical power storage device 7208.

By being connected to an external power source of the hybrid vehicle, the electrical power storage device 7208 is also able to be supplied with electrical power from the external power source via the charging port 7211 taken as an input port, and to store the received electrical power therein.

Although not shown, an information processing device that performs information processing related to vehicle control on the basis of information related to the secondary battery may be provided. Examples of such an information processing device include a battery level display device and the like.

It should be understood that the above description has been given by taking as an example the series hybrid vehicle that travels by a motor using the electrical power generated by the generator power by the engine, or using the electrical power temporarily stored in the battery. However, the present technology is also effectively applicable to a parallel hybrid vehicle that uses outputs of both an engine and a motor as drive sources, and uses three traveling methods while appropriately switching the same. The three methods are: traveling only by the engine; traveling only by the motor; and traveling by the engine and the motor. Moreover, the present technology is also effectively applicable to a so-called electric vehicle that travels by being driven only by a drive motor without using an engine.

The description has been given above of the example of the hybrid vehicle 7200 to which the technique according to the present technology is applicable. The technique according to the present technology is suitably applicable to the electrical power storage device 7208 among the configurations described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery unit;
a housing portion;
a first bus bar on a positive electrode side of the battery unit, the first bus bar being disposed inside the housing portion;
a second bus bar on a negative electrode side of the battery unit, the second bus bar being disposed inside the housing portion;
a positive electrode output terminal connected to the first bus bar;
a negative electrode output terminal connected to the second bus bar;
a first moving member of which movement in a rotation direction is configured to be regulated by a first accommodating portion provided inside the housing portion;
a second moving member of which movement in the rotation direction is configured to be regulated by a second accommodating portion provided inside the housing portion;
a first fastening member to be fastened to the first moving member; and
a second fastening member to be fastened to the second moving member, wherein
each of the housing portion, the positive electrode output terminal, the first bus bar and the first moving member has an opening configured to receive insertion of the first fastening member,
each of the housing portion, the negative electrode output terminal, the second bus bar and the second moving member has an opening configured to receive insertion of the second fastening member,
the first moving member is movable in a direction to the first bus bar in the first accommodating portion after fastening of the first fastening member, and the first bus bar and the positive electrode output terminal are brought into contact with each other by the movement, and
the second moving member is movable in a direction to the second bus bar in the second accommodating portion after fastening of the second fastening member, and the second bus bar and the negative electrode output terminal are brought into contact with each other by the movement.

2. A battery pack comprising:
a battery unit;
a housing portion;
a first bus bar on a positive electrode side of the battery unit, the first bus bar being disposed inside the housing portion;
a second bus bar on a negative electrode side of the battery unit, the second bus bar being disposed inside the housing portion;
a positive electrode output terminal connected to the first bus bar;
a negative electrode output terminal connected to the second bus bar;
a first moving member of which movement in a rotation direction is configured to be regulated by a first accommodating portion provided inside the housing portion; and
a second moving member of which movement in the rotation direction is configured to be regulated by a second accommodating portion provided inside the housing portion, wherein
each of the housing portion, the positive electrode output terminal, the first bus bar and the first moving member has an opening configured to receive insertion of the first fastening member,
each of the housing portion, the negative electrode output terminal, the second bus bar and the second moving member has an opening configured to receive insertion of the second fastening member,
by fastening of the first fastening member to the first moving member, the first moving member and the first bus bar are in contact with each other, and the first bus bar and the positive electrode output terminal are in contact with each other, and
by fastening of the second fastening member to the second moving member, the second moving member and the second bus bar are in contact with each other, and the second bus bar and the negative electrode output terminal are in contact with each other.

3. The battery pack according to claim 2, wherein
the positive electrode output terminal is disposed from an inside of the housing portion to an outside of the housing portion, and
the negative electrode output terminal is disposed from the inside of the housing portion to the outside of the housing portion.

4. The battery pack according to claim 2, wherein
the first bus bar and the positive electrode output terminal are provided between the first fastening member and the first moving member, and
the second bus bar and the negative electrode output terminal are provided between the second fastening member and the second moving member.

5. The battery pack according to claim 3, wherein
the first bus bar and the positive electrode output terminal are provided between the first fastening member and the first moving member, and
the second bus bar and the negative electrode output terminal are provided between the second fastening member and the second moving member.

6. The battery pack according to claim 4, wherein
the first fastening member and the second fastening member include screws,
the first moving member and the second moving member include nuts,
the first bus bar and the positive electrode output terminal are provided between a flange of a first screw and a second nut, and
the second bus bar and the negative electrode output terminal are provided between a flange of a second screw and a second nut.

7. The battery pack according to claim 2, wherein
the first bus bar includes a third bus bar to which a positive electrode tab of the battery unit is connected and a first relay bus bar electrically connected to the third bus bar, and
after the first moving member moves, the first relay bus bar and the positive electrode output terminal are brought into contact with each other.

8. The battery pack according to claim 2, wherein
the second bus bar includes a fourth bus bar to which a negative electrode tab of the battery unit is connected and a second relay bus bar electrically connected to the fourth bus bar, and
after the second moving member moves, the second relay bus bar and the negative electrode output terminal are brought into contact with each other.

9. The battery pack according to claim 2, wherein
the battery unit includes a plurality of battery cells.

10. The battery pack according to claim 2, wherein
the first bus bar, the second bus bar, the positive electrode output terminal, the negative electrode output terminal, the first moving member, and the second moving member include materials having substantially a same linear expansion coefficient.

11. The battery pack according to claim 2, wherein
the first bus bar, the second bus bar, the positive electrode output terminal, the negative electrode output terminal, the first moving member, and the second moving member include a same metal material.

12. The battery pack according to claim 10, wherein
the first bus bar includes a bus bar connected to a positive electrode tab of a predetermined one of the battery cells, a relay bus bar, and a connecting portion provided between the bus bar and the relay bus bar.

13. The battery pack according to claim 12, wherein
the connecting portion includes one or more of a harness, a conductive metal plate, a fuse, a field effect transistor (FET), and a positive temperature coefficient (PTC) thermistor.

14. A method for manufacturing a battery pack including:
a battery unit;
a housing portion;
a first bus bar on a positive electrode side of the battery unit, the first bus bar being disposed inside the housing portion;
a second bus bar on a negative electrode side of the battery unit, the second bus bar being disposed inside the housing portion;
a positive electrode output terminal connected to the first bus bar;
a negative electrode output terminal connected to the second bus bar;
a first moving member of which movement in a rotation direction is configured to be regulated by a first accommodating portion provided inside the housing portion; and
a second moving member of which movement in the rotation direction is configured to be regulated by a second accommodating portion provided inside the housing portion, in which
each of the housing portion, the positive electrode output terminal, the first bus bar and the first moving member has an opening configured to receive insertion of the first fastening member, and
each of the housing portion, the negative electrode output terminal, the second bus bar and the second moving member has an opening configured to receive insertion of the second fastening member,
the method comprising the steps of:
moving the first moving member in the first accommodating portion by fastening the first fastening member to the first moving member from an outside of the housing portion, and by moving the first moving member, bringing the first moving member and the first bus bar into contact with each other, and bringing the first bus bar and the positive electrode output terminal into contact with each other; and
moving the second moving member in the second accommodating portion by fastening the second fastening member to the second moving member from the outside of the housing portion, and by moving the second moving member, bringing the second moving member and the second bus bar into contact with each other, and bringing the second bus bar and the negative electrode output terminal into contact with each other.

15. An electronic device comprising:
the battery pack according to claim 1.

16. A power tool comprising:
the battery pack according to claim 1.

17. An electric vehicle comprising:
the battery pack according to claim 1.
